(19) United States
(12) Patent Application Publication
(10) Pub. No.: US 2015/0136275 A1
(43) Pub. Date: May 21, 2015

(54) Shower Flower Water Collection Device

(71) Applicant: William Field Wales, Fairfield, CT (US)

(72) Inventor: William Field Wales, Fairfield, CT (US)

(21) Appl. No.: 14/484,617

(22) Filed: Sep. 12, 2014

Related U.S. Application Data
(60) Provisional application No. 61/906,285, filed on Nov. 19, 2013.

(51) Int. Cl. B65B 39/00

(52) U.S. Cl. CPC A01G 25/14; B67C 11/00; B65B 3/06
USPC 141/340

(57) ABSTRACT

A shower water collection device configured to capture pre-shower water which once full may easily be sealed to prevent contamination of the collected water until the water can be used for another purpose. A shower water collection device further including an inverted umbrella type funnel for increased surface area and enhanced water collection.

### RELATED APPLICATION

This application claims the benefit of priority of U.S. Provisional Application No. 61/906,285 filed Nov. 19, 2013, the contents of which are incorporated hereby in its entirety by reference.

### FIELD OF THE INVENTION

The present invention pertains generally to water collection devices. More particularly, the present invention pertains to a shower water collection device configured to capture pre-shower water which once full may easily be sealed to prevent contamination of the collected water until the water can be used for another purpose.

### BACKGROUND OF THE ART

In 1990, 30 states in the US reported ‘water-stress’ conditions. In 2000, the number of states reporting water-stress rose to 40. By 2009, the number rose to 45. There is a worsening trend in water supply nationwide. Taking measures at home to conserve water not only saves you money, it also is of benefit to the greater community.

Saving water at home does not require any significant cost outlay. Although there are water-saving appliances and water conservation systems such as rain barrels, drip irrigation and on-demand water heaters which are more expensive, the bulk of water saving methods can be achieved at little cost. For example, 75% of water used indoors is in the bathroom and even the use of simple methods like tank banks, low-flow showerheads and faucet aerators cannot eliminate the habitual wasting of water by bathers. Most individuals who take a daily shower waste a significant amount of cold or lukewarm water while waiting for the shower water to heat to a preferred temperature.

A variety of shower water collection devices are known in the art, for example, U.S. Pat. No. 5,140,174 issued to Horenstein et al. discloses a device for saving water while waiting for shower water to heat up wherein the device consists of an elongated flexible and collapsible tube, the tube having a cuff at the top to remain around the shower head and a cover at the bottom, the cover to prevent grey water from collecting in the contain used with the device. This device may prove inconvenient for individuals with mobility issues and/or the elderly.

Another example, U.S. Pat. No. 5,168,586 issued to Small discloses a device for reclaiming shower waste water for use for filing toilets and watering garden, wherein the device is a molded reservoir that takes up the entire bottom of the bathtub, the reservoir being further comprised of smaller tanks that may be individually removed from the reservoir for use of the collected water. This device is large and bulky and its size alone is likely to deter many from attempting to install the device in their bathtub.

U.S. Pat. No. 5,345,625 issued to Diemand discloses a waste water recovery system including a storage tank, a suction pump connected between the shower floor drain and the tank of the toilet for supplying water for use to flush the toilet. This device requires installation of the collection tank and connector between the shower, tank and toilet.

U.S. Pat. No. 5,862,544 issued to Placencia discloses an apparatus for collecting fresh water flow from a shower including a support frame, a water flow diverter and at least one collection container supported in the frame. This appartus requires mounting of the support frame to the wall with a plurality of lag bolts.

U.S. Pat. No. 6,581,218 issued to Koepenick discloses a water conservation system including a pair of receptacles for placement on the shower floor, one receptacle for collection of clean water and the other receptacle for collection of used shower water. The pair of receptacles requires the placement of a dowel between the receptacles to prevent movement of the receptacles during use. The requirement of the dowel may make separation of the receptacles cumbersome once use of the collected water is desired.

U.S. Pat. Pub. No. 2010/0051107 by Crawford discloses a shower water-saving device for placement in the shower to collect fresh and used water in the same container which may be transformed into a watering bucket and be used to water household plants, garden plants or lawns.

In light of the above, it is an object of the present invention to provide the desired features described herein as well as additional advantages such as being lightweight, affordable and relatively simple to manufacture.

### SUMMARY OF THE INVENTION

The present invention is directed to solving the deficiency in the art pertaining to pre-shower water waste and collection. It is an object of the present invention to provide a shower water collection device that may seal water tight to prevent the contamination of already collected lead shower water resulting in the collection of fresh water for future use.

It is another object of the present invention to provide a shower water collection device with a deployable umbrella type funnel for increased surface area and increased water collection. Another object of the present invention is to provide a shower water collection device with a deployable umbrella type funnel that may be hidden during non-use (i.e. closed configuration) such that the funnel folds neatly into the collection reservoir when not in use.

It is yet another object of the present invention to reduce water waste resulting from the turning on of the shower in order to allow the water to heat to the desired temperature.

It is still another object of the present invention to provide a shower water collection device that once the umbrella type funnel is deployed the device resembles a flower such that the individual segments of the funnel resemble the petals of a flower.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates a side view of the shower water collection device in a preferred embodiment with the device in the open position.

FIG. 2 illustrates a top view of the shower water collection device shown in FIG. 1.

FIG. 3 illustrates a side view of the shower water collection device in a preferred embodiment with the device in the closed position.

FIG. 4 illustrates a top view of the shower water collection device shown in FIG. 3.

FIG. 5 illustrates a side view of the shower water collection device in use.

### DETAILED DESCRIPTION OF THE INVENTION

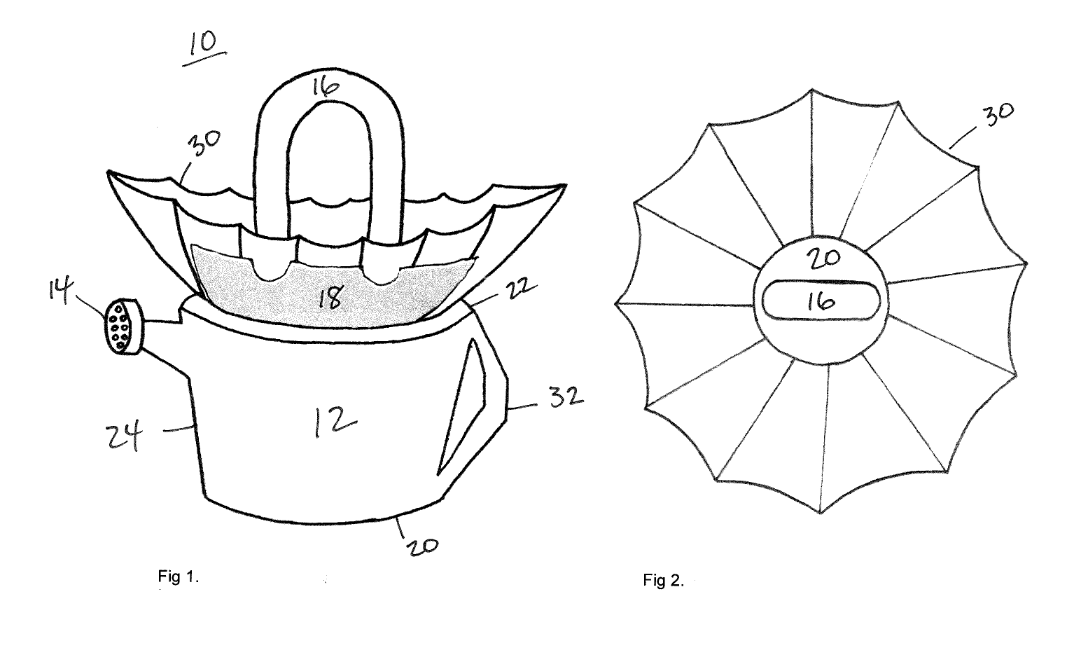

Figures are not drawn to scale and are only provided to illustrate the instant invention. A shower water collection device is illustrated in a side perspective view in FIG. 1. The shower water collection device 10 is comprised of a reservoir 12 for collecting leading shower water, the reservoir 12 being defined by a bottom 20 with a first diameter and a top 22 with a second diameter and at least one side wall 24 extending from the bottom 20 to the top 22 such that the side wall 24 extends at an angle greater than 90° from the bottom 20. The at least one side wall further includes a watering spout 14 for ease of watering flower beds and/or household plants. The shower water collection device 10 further includes a second handle 32 located on the at least one side wall opposite the watering spout 14 for aiding in the lifting and carrying of the device 10. The top 22 is further comprised of a seal 18 and a handle 16. The seal 18 may be in the shape of a circle with a diameter less than the diameter of the top 22. In an alternative embodiment the seal 18 may be a square or virtually any shape that allows for the proper function of the shower water collection device 10. In the open configuration, the handle 16 is extended vertically from the top 22 such that an inverted umbrella funnel 30 protrudes from the reservoir 12 and fans out at the diameter of the seal 18 to provide greater surface area for increased water collection. While the inverted umbrella funnel 30 is deployed the increased surface area of the funnel 30 allows for bulk water collection.

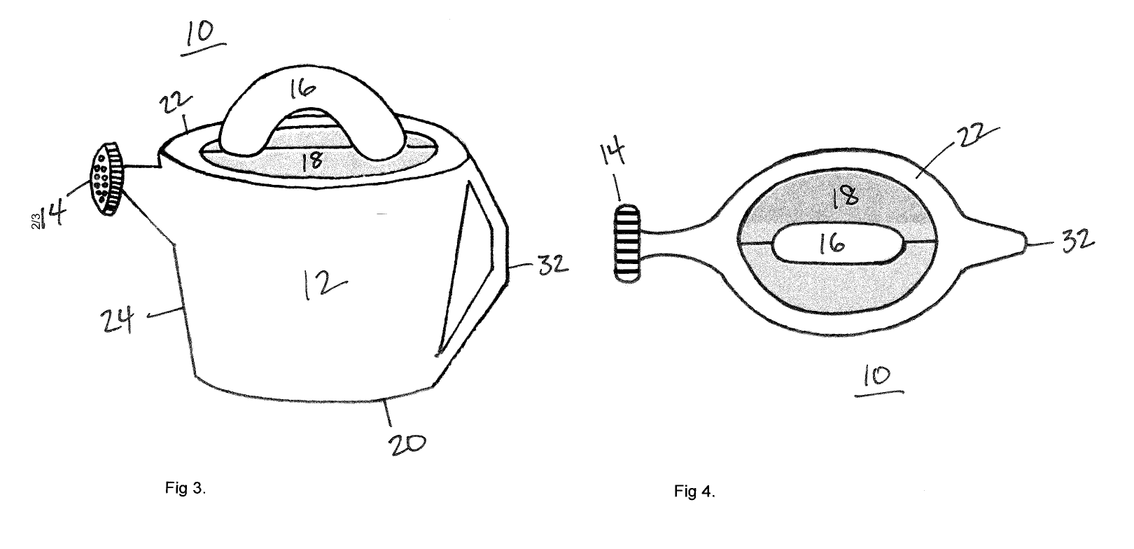

With reference to FIG. 2, a top view of the shower water collection device of FIG. 1 is illustrated. When the umbrella 30 is in the open position, the bottom 20 of the device can be seen encompassing the handle 16. It is this opening about the handle 16 that facilitates water collection in the reservoir of the shower water collection device.

With reference to FIG. 3, a shower water collection device in a second embodiment is illustrated in a side perspective view. Shown is the shower water collection device 10 comprised of a reservoir 12 for collecting leading shower water, the reservoir 12 being defined by a bottom 20 with a first diameter and a top 22 with a second diameter and at least one side wall 24 extending from the bottom 20 to the top 22 such that the side wall 24 extends at an angle greater than 90° from the bottom 20. The at least one side wall further includes a watering spout 14 for ease of watering flower beds and/or household plants. The top 22 is further comprised of a seal 18 and a handle 16. In the closed configuration, the handle 16 protrudes out from the seal 18 while the seal 18 remains water tight around the handle 16. The water tight seal 18 prevents contaminants such as grey shower water and soap from entering the reservoir 12 when the shower water collection device 10 is in the closed configuration.

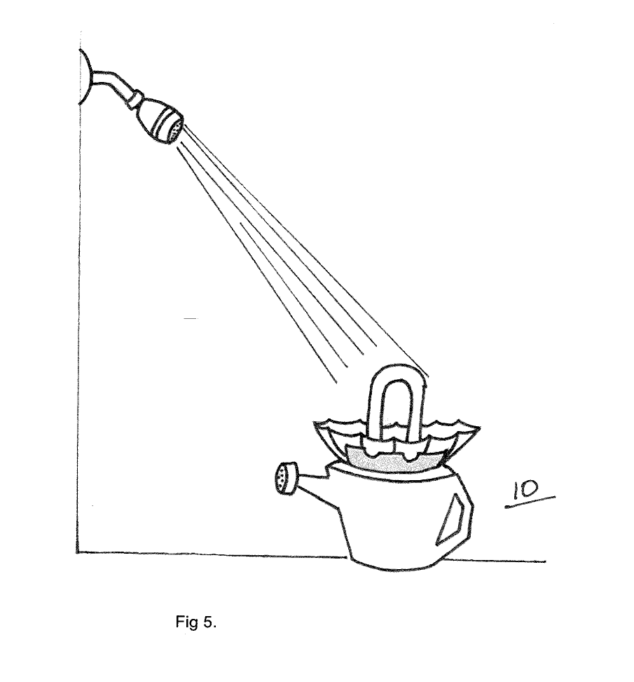

With reference to FIG. 4, a top view of the shower water collection device of FIG. 3 is illustrated. When the umbrella (not shown) is collapsed, the seal 18 remains water tight about the handle 16 to prevent soapy water was entering the device during the remainder of the shower.

With reference to FIG. 5, a shower water collection device 10 is shown in use collecting lead shower water.

One embodiment of the present invention provides a shower water collection device for collecting lead shower water that would typically be wasted. The shower water collection device may be made from blow molded plastic or metal. In a preferred embodiment the shower water collection device is made from lightweight molded plastic.

In another embodiment, the present invention provides a shower water collection device capable of being closed and sealed tight to prevent contamination of the collected water resulting in the collection of fresh water for future use.

In yet another embodiment, the present invention provides a shower water collection device with an inverted umbrella type funnel for increasing surface area for increased water collection. The inverted umbrella funnel may be made of thin plastic or water proof fabric. In a preferred embodiment, the inverted umbrella funnel may be thin plastic similar to the water collection device reservoir. In a more preferred embodiment, the segments of the funnel may resemble any shape similar to the petals of a flower.

In still another embodiment, the present invention provides a shower water collection device with an optional hand pump attachment for pressurizing the reservoir in order to provide for different spray patterns. The hand pump may be further comprised of a hose, wand and interchangeable nozzle to allow for a variety of dispensing options. In a preferred embodiment, the hose, wand and nozzles may be made from molded plastic, rubber or vinyl.

In still another embodiment, the present invention provides a method for collecting lead shower water, the method comprising the steps of:

a) placing a shower water collection device in the shower stall or bathtub;

b) lifting up on the handle of the shower water collection device to deploy the inverted umbrella funnel;

c) turning on the water such that water from the shower head is directed toward the inverted umbrella funnel;

d) collecting water in the shower water collection device until the desired water temperature is reached;

e) pushing the handle of the shower water collection device down and into the collection device reservoir thereby sealing the device; and

f) moving the shower water collection device to one side of the shower stall or bathtub until use of the collected water is desired.

In yet another embodiment, the present invention provides a water collection adapter for an existing reservoir. The reservoir may be selected from the group consisting of a pail, bucket, watering can, barrel, a trash can or any reservoir that may be used to collect shower or rainwater.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

While the particular shower water collection device as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A shower water collection device comprising:
a reservoir defined by a bottom having a first diameter and a top having a second diameter;
at least one side wall extending from the bottom to the top such that the side wall extends at an angle greater than 90° from the bottom;
a watering spout located on the at least one side wall;
an inverted umbrella funnel which may be deployed for water collection; and
a handle located on the top of the reservoir for opening and closing a water-tight seal.

2. The shower water collection device of claim 1, wherein the inverted umbrella funnel may be segmented to resemble the petals of a flower when deployed for water collection.

3. The shower water collection device of claim 1, wherein lifting the handle located at the top of the reservoir opens the water-tight seal and deploys the inverted umbrella funnel.

4. The shower water collection device of claim 3, wherein lowering the handle located at the top of the reservoir results in the withdrawal of the inverted umbrella funnel and the closing of the water-tight seal.

5. The shower water collection device of claim 1, further including a second handle located on the at least one side wall opposite the watering spout for aiding in the lifting and carrying of the device.

6. A method for collection of lead shower water using a shower water collection device, wherein the device comprises:
a reservoir defined by a bottom having a first diameter and a top having a second diameter;
at least one side wall extending from the bottom to the top such that the side wall extends at an angle greater than 90° from the bottom;
a watering spout located on the at least one side wall;
an inverted umbrella funnel which may be deployed for water collection; and
a handle located on the top of the reservoir for opening and closing a water-tight seal.

7. The method of claim 6, wherein the inverted umbrella funnel may be segmented to resemble the petals of a flower when deployed for water collection.

8. The method of claim 6, wherein lifting the handle located at the top of the reservoir opens the water-tight seal and deploys the inverted umbrella funnel.

9. The method of claim 8, wherein lowering the handle located at the top of the reservoir results in the collapsing of the inverted umbrella funnel and the closing of the water-tight seal.

10. The method of claim 6, wherein the device further includes a second handle located on the at least one side wall opposite the watering spout for aiding in the lifting and carrying of the device.

11. A method for collecting lead shower water, the method comprising the steps of
a) placing a shower water collection device in the shower stall or bathtub;
b) lifting up on the handle of the shower water collection device to deploy the inverted umbrella type funnel;
c) turning on the water such that water from the shower head is directed toward the inverted umbrella type funnel;
d) collecting water in the shower water collection device until the desired water temperature is reached;
e) pushing the handle of the shower water collection device down and into the collection device reservoir thereby collapsing the inverted umbrella type funnel and sealing the device; and
moving the shower water collection device to one side of the shower stall or bathtub until use of the collected water is desired.
